(19) United States
(12) Patent Application Publication
(10) Pub. No.: US 2007/0070640 A1
(43) Pub. Date: Mar. 29, 2007

(54) Display sign

(76) Inventor: Conrad Sexton, Bradford (GB)

Correspondence Address: HEAD, JOHNSON & KACHIGIAN, 228 W 17TH PLACE, TULSA, OK, 74119, US

(21) Appl. No.: 11/527,781

(22) Filed: Sep. 26, 2006

(30) Foreign Application Priority Data
Sep. 29, 2005 (GB) 0519811.4

(51) Int. Cl. B60Q 1/56

(52) U.S. Cl. 362/497

(57) ABSTRACT

A display sign is provided, such as a vehicle registration plate. The display sign has data in the form of one or more numbers, letters, images and/or characters displayed thereon. At least part of the display sign is formed from or includes electroluminescent material. The display sign is connected to or is associated with a power supply means, such that when the electroluminescent material receives power from the power supply means, light is emitted from the electroluminescent material.

### CROSS-REFERENCES TO RELATED APPLICATION

This application claims priority to British Patent Application No. 0519811.4 filed 29 Sep. 2005.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### FIELD OF THE INVENTION

This invention relates to a display sign.

Although the following description refers to a display sign in the form of a vehicle registration plate of a type that is located on the front and/or rear of the exterior of the vehicle to identify the vehicle registration, it will be appreciated by persons skilled in the art that the display sign can be any suitable sign and, when in the form of a vehicle registration plate, can be used in or at any suitable location on a vehicle to display information, images, data and/or the like thereon other than vehicle registration data.

Conventional vehicle registration plates typically include a metal or plastic plate with data in the form of one or more numbers, letters, images and/or characters displayed thereon. The data can be integrally formed with the plate, attached thereto or printed/formed thereon. The plate may include a reflective layer on which the data is placed so that light shining onto the reflective layer is reflected to aid visibility of the plate. The aesthetic appeal of conventional vehicle plates is limiting, and the reflective layer alone is often insufficient to allow the plate to be clearly seen by an observer.

### BRIEF SUMMARY OF THE INVENTION

It is an aim of the present invention to provide a display sign, such as a vehicle registration plate, which has increased visibility to an observer.

It is a further aim of the present invention to provide a display sign, such as a vehicle registration plate, which has increased aesthetic appeal.

According to a first aspect of the present invention there is provided a display sign having data in the form of one or more numbers, letters, images and/or characters displayed thereon, and wherein at least part of the display sign is formed from or includes electroluminescent material. The display sign is connected to or is associated with power supply means, such that when the electroluminescent material receives power from the power supply means, light is emitted from the electroluminescent material.

Thus, the electroluminescent material provided on the display sign typically lights up the sign or causes the sign to luminesce, at least in part, thereby providing an improved aesthetic effect and/or increasing the visibility of the same to a user.

Preferably the display sign is a vehicle registration plate.

The term vehicle registration plate (hereinafter referred to as VR plate) refers to any of the vehicle plates provided on the front and/or rear of a vehicle to allow the registration or owner details of the vehicle to be displayed, to a display sign that may be placed in a window or on a surface of the vehicle, so as to display a message, such as vehicle braking, and/or the like.

In one embodiment, the display sign includes two or more or a plurality of layers of material. The electroluminescent material typically includes at least one of the layers of the sign. The layers are typically provided adjacent to each other in an overlapping or laminate type of arrangement.

Preferably, the plurality of layers are in the form of sheet-like material and/or plate-like material. The layers are typically substantially flat and planar and are preferably arranged substantially parallel.

Preferably, at least one substantially transparent and/or semi-transparent layer of material is located directly or indirectly in front of the electroluminescent material.

The transparent or semi-transparent layer can include or be used for the purposes of any or any combination of the data being provided thereon, reflective material being provided thereon or formed therewith so as to allow headlight beams or other lights falling thereon to be reflected, a protective cover to prevent damage and/or ingress of moisture and/or dirt and/or the like.

Preferably, the transparent or semi-transparent layer of material includes one or more plastic, paper and/or acetate layers.

The plurality of layers can be joined or held together by any or any combination of friction fit, in abutting relationship or via attachment means, such as heat welding, adhesive, one or more clips, screws, nuts and bolts, hook & loop fastening, inter-engaging members, ties and/or the like.

Preferably, the display sign includes a housing and the electroluminescent material is provided in or on the housing. In one embodiment, the plurality of layers forming the display sign is located in or on the housing.

The housing can be provided with attachment means for allowing attachment of the housing to or suspended from a suitable surface, such as in or on a vehicle. The attachment means can include any or any combination of one or more apertures for the location of attachment means, one or more screws, inter-engaging members, welding, adhesive, nuts and bolts, hook & loop fastening and/or the like.

The power supply means used to power the electroluminescent material can include a mains power supply, power supply means of a vehicle and/or can include one or more batteries separate to the power supply of the vehicle and/or mains power supply.

In one embodiment, one or more light emitting diodes (LEDs) are associated with the sign. The LEDs can be provided with or included in the one or more layers, such as the overlapping layers, forming the sign and/or can be provided on the housing of the sign. The LEDs typically increase the aesthetic appeal and illumination of the VR plate to a user. However, the LEDs could be used to replicate or replace one of more other light emitting devices of the vehicle, such as for example, brake lights, hazard warning lights, fog lights, reverse lights, headlights and/or the like.

Thus, in one example where the sign is provided on a vehicle, one or more of the LEDs on the display sign are in communication with or associated one or more other light emitting devices provided on the vehicle.

A plurality of LEDs are typically provided adjacent a peripheral edge of the display sign. The LEDs in one example are in the form of substantially flat LEDs to allow the display sign to be provided in a compact and lightweight design.

Preferably, control means are provided for controlling the luminescence of the electroluminescent material and/or the LEDs. The control means can be provided on or associated with the display sign and/or can be provided in the vehicle, such as on the vehicle dash board. For example, the control means can be used to switch the electroluminescent material and/or the LEDs between on and off conditions, between bright/dim conditions and/or between flashing conditions.

In one embodiment, the display sign includes at least a base layer, an intermediate electroluminescent containing layer, and a transparent or semi-transparent outer layer provided in overlapping arrangement.

One or more LEDs can be provided around the sign or on a layer located between the base layer and intermediate electroluminescent containing layer.

An outer cover can be provided on or over the outer layer to protect the same.

Material in the shape of data can be located between the intermediate and outer layer, on the outer layer or on an outer cover provided over the outer layer.

According to a second aspect of the present intention there is provided a vehicle registration plate. The vehicle registration plate having data in the form of one or more numbers, letters, images and/or characters displayed thereof. At least part of the vehicle registration plate is formed from or includes electroluminescent material and the plate is connected to or is associated with power supply means, such that when the electroluminescent material receives power from the power supply means, light is emitted from the electroluminescent material.

According to a further aspect of the present invention there is provided a method of assembling a display sign. The display sign has data in the form of one or more numbers, letters, images and/or characters displayed thereon. The method includes locating at least one layer of electroluminescent material on a backing member and connecting power supply means to the electroluminescent material, such that when the electroluminescent material receives power from the power supply means, light is emitted from the electroluminescent material layer.

### BRIEF DESCRIPTION OF THE SEVERAL VIEWS OF THE DRAWINGS

An embodiment of the present invention will now be described with reference to the accompanying figures.

FIG. 1a illustrates an example of a backing plate for use with a VR Plate.

FIG. 1b illustrates an LED Plate, including a plurality of LEDs provided around a peripheral edge thereof.

FIG. 1c illustrates an electroluminescent layer formed of electroluminescent material.

FIG. 1d illustrates a semi-transparent layer including light reflective material.

FIG. 1e illustrates the electroluminescent and semi-transparent layers being located together in abutting relationship.

FIG. 1f illustrates the layers in FIG. 1e being located in front of the LED plate of FIG. 1b.

FIG. 1g illustrates a front cover for location over the VR Plate.

FIG. 1h illustrates a further layer showing the vehicle registration data thereon.

FIG. 1i illustrates the further layer located on top of the electroluminescent and semi-transparent layers and the front cover being attached to the backing plate.

### DETAILED DESCRIPTION OF THE PREFERRED EMBODIMENTS

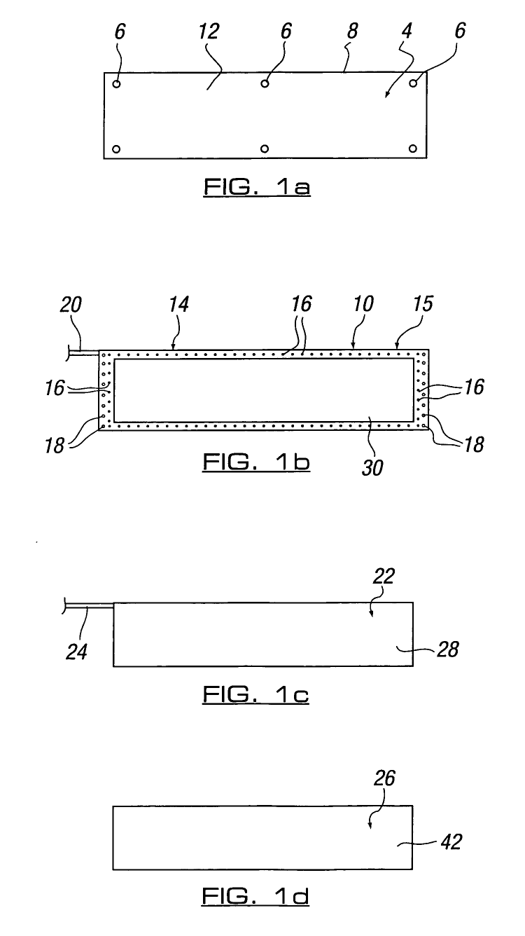

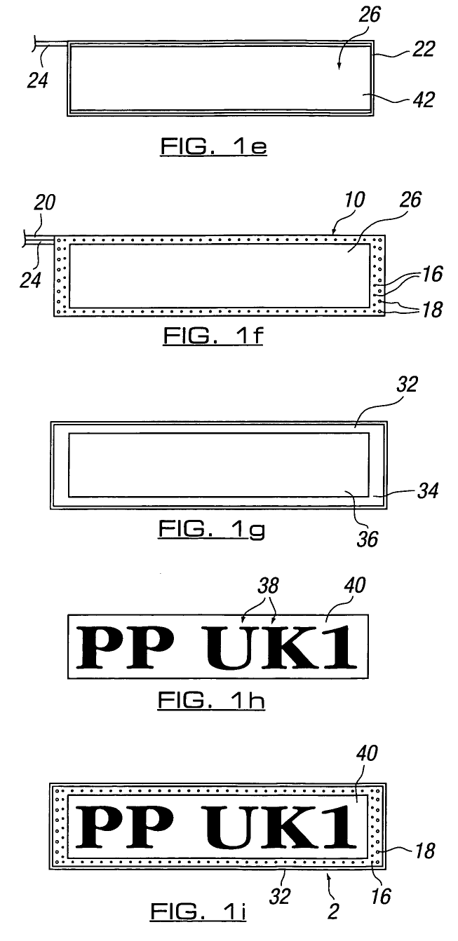

Referring to the Figures, there is illustrated an embodiment of the present invention in the form of a vehicle registration plate (VR Plate) 2. VR Plate 2 includes a rear backing plate 4, shown in FIG. 1a. In this example, backing plate 4 is formed from 5 mm plastic with six counter sunk apertures 6 provided at spaced apart intervals adjacent a peripheral edge 8 thereof. Apertures 6 are provided for receiving bolts therethrough for attaching the VR Plate 2 to a surface of a vehicle.

An LED plate 10, shown in FIG. 1b, has a rear surface for location adjacent a front surface 12 of backing plate 4 when VR Plate 2 is assembled. LED plate 10 is formed from 3 mm plastic in this example. A plurality of LEDs 14 are provided around a peripheral edge 15 thereof. Some of the LEDs 16 are red and are in communication with brake lights of the vehicle, such that when the brake lights of the vehicle are activated or switched on, the red LEDs are lit. Some of the LEDs 18 are amber and are in communication with indicator lights of the vehicle, such that when the indicator lights of the vehicle are activated or switched on, the amber LEDs 18 are lit. The LEDs can be protruding LEDs or can be substantially flat LEDs as required. Electrical wiring 20 connecting the LEDs to a power source protrudes from an outer edge of plate 10. The LEDs can be provided in any suitable arrangement, pattern and/or color as required.

An electroluminescent layer 22 is then provided in a sheet-like form, with electrical wiring 24 for connecting the layer to a power source protruding from an outer edge thereof, as shown in FIG. 1c.

A semi-transparent layer 26 formed from light reflective material, as shown in FIG. 1d, is located on the front surface 28 of electroluminescent layer 22, as shown in FIG. 1c, and laminated to the same. The laminated layers 22, 26 are then located in and attached to a center portion 30 of LED plate 10, such that the LEDs are located around the periphery of the laminated layers 22, 26, as shown in FIG. 1f. Thus, the dimensions of layers 22 and 26 are substantially the same and are less than the dimensions of center portion 30 of LED plate 10.

A front panel cover 32, as shown in FIG. 1g, is then located over layers 22, 26 and plate 10 and attached to backing plate 4. Cover 32 has a border portion 34 provided around a peripheral edge thereof for location over the LEDs of LED Plate 10 and a central portion 36 for location over layers 22, 26. Cover 32 is typically formed from substantially transparent material to allow the lower layers to be visible therethrough. Alternatively, cover 32 can be in the form of a frame defining the center portion and the border portion.

The data 38 to be placed on the plate, which in the example shown in FIG. 1h is in the form of a vehicle registration “PP UK1”, is adhered to the front surface of cover 32. Data 38 is provided on a transparent acetate layer 40. Layer 40 can be located over cover 32 or can be laminated on top of front surface 42 of reflective layer 26 as required. Furthermore, layer 40 is typically detachably attached to the lower layers of the plate so that the plate can be easily transferred to different vehicles if required and/or different data can be displayed on the plate if required.

It will be appreciated that any or any combination of the layers can be provided with the electroluminescent material layer in the present invention, and the layers can be provided in any suitable order.

The electrical wiring 20, 24 typically is connected to electrical wiring of the vehicle, thereby allowing the luminescence of the plate and the LEDs to be controlled by controls provided in the vehicle. For example, a control switch activating the headlights of the vehicle can also be used to control luminescence of the plate. A separate plate control button could be provided if required. Other electrical contracts can be provided if required other than wiring. In one example, a 12V inverter is provided to power the plate.

The vehicle plate can be provided in any suitable size, shape and/or design and the one or more layers can be provided in any suitable color and/or design.

1. A display sign, said display sign comprising:
data in the form of one or more numbers, letters, images and/or characters displayed thereon;
at least part of said display sign is formed from or includes electroluminescent material; and
power supply means is connected to or is associated with the display sign, such that when the electroluminescent material receives power from the power supply means, light is emitted from the electroluminescent material.

2. The display sign according to claim 1 wherein said display sign includes two or more layers of material and said electroluminescent material includes one of the layers.

3. The display sign according to claim 2 wherein said layers are provided in an overlapping or laminate arrangement on said display sign.

4. The display sign according to claim 2 wherein at least one substantially transparent and/or semi-transparent layer of material is located in front of said electroluminescent material on said display sign.

5. The display sign according to claim 4 wherein said at least one substantially transparent and/or semi-transparent layer is or includes a plastic, paper and/or acetate layer.

6. The display sign according to claim 2 wherein the one or more layers are held together by any or any combination of friction fit, heat welding, adhesive, one or more clips, screws, nuts and bolts, hook and loop fastening, ties or inter-engaging members.

7. The display sign according to claim 1 wherein said sign further includes a housing and said electroluminescent material is located in or on the housing.

8. The display sign according to claim 7 wherein a plurality of layers forming said display sign are located in or on said housing.

9. The display sign according to claim 7 wherein said housing is provided with attachment means for allowing attachment of said housing to a suitable surface.

10. The display sign according to claim 1 wherein said power supply includes one or more batteries.

11. The display sign according to claim 1 wherein said power supply includes power supply means of a vehicle.

12. The display sign according to claim 1 wherein said power supply is a main power supply.

13. The display sign according to claim 1 wherein one or more light emitting diodes are associated with said display sign.

14. The display sign according to claim 13 wherein said one or more light emitting diodes are provided with or included on one or more layers forming said display sign.

15. A display sign according to claim 13 wherein said one or more light emitting diodes are provided on a housing of said display sign.

16. A display sign according to claim 13 wherein said sign is provided on a vehicle and said light emitting diodes are in communication with or associated with one or more other light emitting devices provided on a vehicle.

17. A display sign according to claim 16 wherein said one or more other light emitting devices on the vehicle include any or any combination of brake lights, hazard warning lights, fog lights, headlights or reverse lights.

18. A display sign according to claim 1 wherein said control means are provided for controlling the luminescence of said electroluminescent material and/or one or more light emitting diodes provided on said sign.

19. A display sign according to claim 18 wherein said control means are provided on said sign.

20. A display sign according to claim 18 wherein said sign is provided in or on a vehicle and said control means are located in a vehicle.

21. A display sign according to claim 1 wherein said sign further includes at least a base layer, an intermediate electroluminescent containing layer and a transparent or semi-transparent layer outer layer provided in overlapping arrangement.

22. A display sign according to claim 21 wherein one or more light emitting diodes are provided around said sign or on a layer located between said base layer and said intermediate electroluminescent containing layer.

23. A display layer according to claim 21 wherein an outer cover is provided on or over said outer layer to protect the same.

24. A display sign according to claim 21 wherein material in the shape of data is located between said intermediate and said outer layer, on said outer layer or on an outer cover provided over said outer layer.

25. A display sign according to claim 1 in the form of a vehicle registration plate.

26. A vehicle registration plate, said vehicle registration plate comprising:
data in the form of one or more numbers, letters, images and/or characters displayed thereon;
electroluminescent material includes or forms at least part of said vehicle registration plate; and
a power supply means is connected to or is associated with the vehicle registration plate, such that when the electroluminescent material receives power from the power supply means, light is emitted from the electroluminescent material.

27. A method of assembling a display sign having data in the form of one or more numbers, letters, images and/or characters displayed thereon, said method comprising the steps:
locating at least one layer of electroluminescent material on a backing member; and
connecting a power supply means to the electroluminescent material, such that when the electroluminescent material receives power from the power supply means, light is emitted from the electroluminescent material layer.
